(19) United States
(12) Patent Application Publication
(10) Pub. No.: US 2014/0220232 A1
(43) Pub. Date: Aug. 7, 2014

(54) EQUIPMENT FOR DECORATING A SECTION

(71) Applicant: Jean-Noel Claveau, Oyonnax (FR)

(72) Inventor: Jean-Noel Claveau, Oyonnax (FR)

(21) Appl. No.: 14/125,678

(22) PCT Filed: Jun. 15, 2012
(86) PCT No.: PCT/FR2012/051353

§ 371 Date: Mar. 27, 2014

(30) Foreign Application Priority Data
Jun. 16, 2011 (FR) 11/01883

(51) Int. Cl. B05D 5/06

(52) U.S. Cl. CPC B05D 5/067
USPC 427/11

(57) ABSTRACT

Equipment for decorating a section, comprising: a cavity filled with a material having a melting temperature corresponding to the temperature suitable for transferring the decorative materials; and a flexible die formed by a resiliently deformable conical casing having an inlet cross-section larger than the cross-section of the section to be decorated and an outlet cross-section smaller than the cross-section of the section to be decorated, said die being surrounded by the melted material and connected to two opposing surfaces of the above-mentioned cavity in order to form a leakproof through-duct.

### BACKGROUND

1. Field of the Invention

The present invention relates to a method for decorating section bars made of PVC, wood, aluminum and the like.

2. State of the Art

Traditionally, this decoration is carried out flat on bars and pressurized for several minutes on a very limited length. This flat decoration cannot sublimate all the outlines of the shaped object at the same time.

For example, a square-sectioned section must be positioned four times under the press for several minutes and the joints are never joining.

The International Patent Application WO/2005/001786 also provided for a device comprising a vibrating heating matrix, and a cone-shaped core in the inlet thereof, to end in the shape of the type of section intended to be sublimated, on infinite lengths. The sublimable ink support, at the outlet of the device, is removed either manually or automatically.

The device according to the invention enables the application of a decorative film and, in this case, no waste support has to be removed.

The principle according to the invention consists in passing at the centre of the matrix, which may be fixed or mobile according to the type of section bar, with a rolling effect which allows a continuous sublimation.

This solution requires providing a very specific die for each section to be decorated. These rigid metal dies are expensive tools specific to each different shape. Designing and producing such metal dies are complex operations when other shapes than a circle, a simple oval or the basic geometric shapes are desired.

### SUMMARY

The present invention aims to overcome the drawbacks of the prior art by providing a solution to decorate different sections having various cross-sections, with an accurate and effective application of the material to be transferred.

To this end, the invention in its broadest sense relates to equipment for decorating a section, characterized in that it comprises a cavity filled with a material having a melting temperature corresponding to the temperature suitable for transferring the decorative materials, and a flexible die formed by a resiliently deformable conical casing having an inlet cross-section larger than the cross-section of the section to be decorated and an outlet cross-section smaller than the cross-section of the section to be decorated, said die being surrounded by the melted material and connected to two opposite faces of said cavity to form a leakproof through-duct.

Advantageously, said conical die consists of polytetrafluorethylene.

According to a preferred embodiment, said fusible material is a bath of non-ferrous metal alloys.

Preferably, the melting temperature of said fusible material ranges from 220 to 280° C.

According to an advantageous alternative solution, said cavity comprises thermal control means.

According to another alternative solution, said cavity comprises pressurizing means.

### DETAILED DESCRIPTION

The present invention will be better understood upon reading the following description which refers to a non restrictive embodiment, illustrated by the accompanying figures wherein:

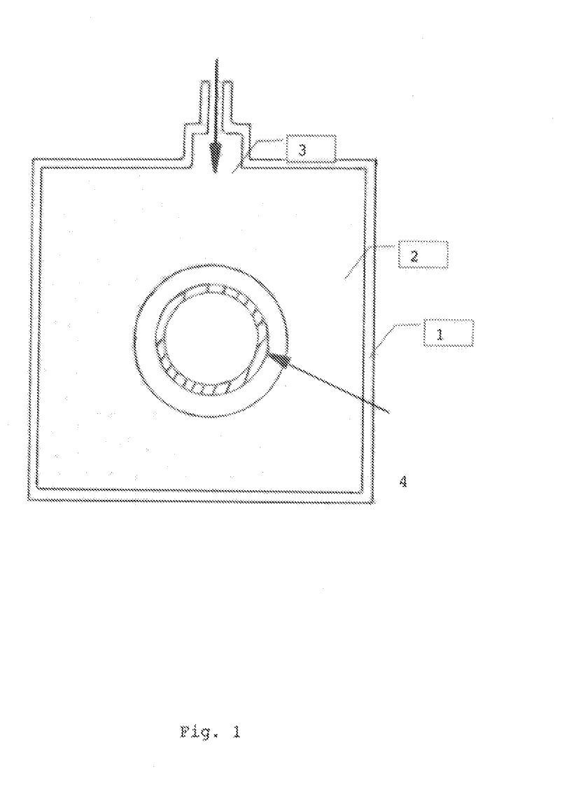

FIG. 1 shows a cross-sectional view of the cavity.

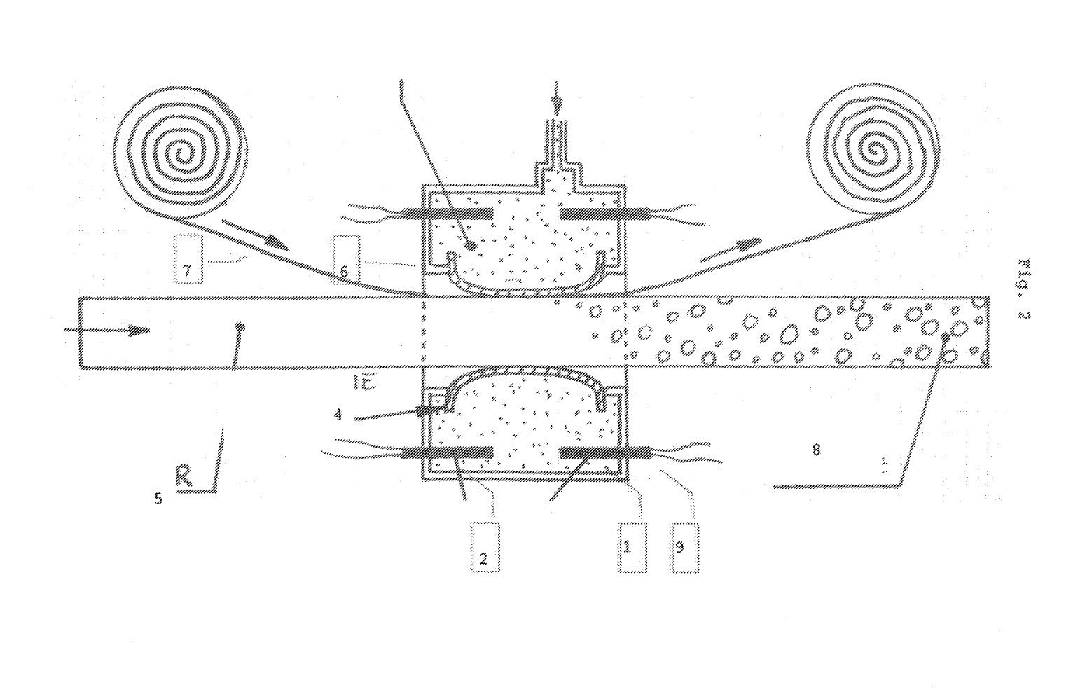

FIG. 2 shows a longitudinal sectional view of the equipment.

The equipment comprises a temperature-controlled rigid cavity 1 shown in longitudinal section in FIG. 1.

This cavity 1 is filled with a phase-change material 2. By way of example, this material is made of:
a tin-, bismuth- and lead-based alloy
an antimony-, tin-, bismuth- and lead-based alloy
a non-ferrous metals-based alloy comprising bismuth.

In particular, the bath is an alloy consisting of 50% Bi, 25% Pb, 12.5% Sn, 12.5% Cd with a melting point of about 70° C., maintained at a temperature of about 250° C.

The cavity 1 has an orifice 3 for filling and pressurizing the bath, and is gone through by a flexible die 4. This flexible die 4 consists of a tubular element made of polytetrafluoroethylene, or Teflon (trade name).

FIG. 2 shows a longitudinal sectional view of a device according to the invention.

The part 5 to be decorated, for example a section made of plastic material, is introduced into the opening 6 of the cavity 1.

This opening 6 leads to the inlet of the flexible die 4 and seals the bath 2.

When the part to be decorated 5 is introduced into the cavity, it pulls a decorative film 7 which moves synchronously along a longitudinal axis of travel. This film fits the external form of the part to be decorated 5 and enters the cavity through the opening 6. The film 7 is made of a sheet of cellulose wadding having a low basis weight, for example 20 g/m².

Other types of transfer film have been considered: a Teflon film, a sheet of transfer paper used for decorating fabric by sublimation, a film of silicone paper, glue, elastomer, natural latex, synthesis latex or a sheet of natural flocked polyisoprene. The flocks are made of cotton fibres, viscose fibres, polyamide fibres, acrylic fibres or polyester fibres.

The flexible sheet of paper as defined above has both the advantage of being very inexpensive and perfectly fitting the outlines of the item to be decorated.

The film 7 is printed with a heat-activatable ink, preferably a sublimable ink or an ink of the “hot melt” type, using a conventional method for transfer printing the image, such as gravure printing, silk screen printing or simply printing with an ink jet printer.

The computer-digitized and processed image is printed with a special sublimable ink on a professional ink jet printer or any suitable printing equipment.

The sublimable inks generally consist of molecules of modest size and weight, with a compromise between the presence of conjugated double bonds and combined cycles making it possible for the molecules to be coloured, and the reduction in the molecular masses so that the molecules can be compatible with sublimation. Using phase-change inks and more particularly thermofusible inks for printing the transfer sheet can also be considered.

The printed transfer film 7 is then applied onto the item to be decorated.

The passage through the die 4 going through the bath 2 causes the heating to a temperature, and for a time required for transferring the heat-activatable ink.

In the absence of information provided by the distributor of the heat-activatable ink, the persons skilled in the art will be able to determine the best conditions, more particularly speed of travel through the cavity, using simple routine tests. For this purpose, first temperature and speed will be selected, and incremented by regular, for example 5° C. steps, until a stage is reached in the quality of the transfer.

The piece then goes out from the bath as a decorated part 8, and the transfer film is recovered.

The temperature-control of the bath 2 is provided by electrodes 9.

1-6. (canceled)

7. Equipment for decorating a section comprising a cavity filled with a material having a melting temperature corresponding to the temperature suitable for transferring the decorative materials, and a flexible die formed by a resiliently deformable conical casing and having an inlet cross-section larger than the cross-section of the section to be decorated and an outlet cross-section smaller than the cross-section of the section to be decorated, said die being surrounded by the melted material and connected to two opposite faces of said cavity to form a leakproof through-duct.

8. Equipment for decorating a section according to claim 7, wherein said conical die consists of polytetrafluoroethylene.

9. Equipment for decorating a section according to claim 7, wherein said fusible material is a bath of non-ferrous metal alloys.

10. Equipment for decorating a section according to claim 7, wherein the melting temperature of said fusible material ranges from 220 to 280° C.

11. Equipment for decorating a section according to claim 7, wherein said cavity comprises thermal control means.

12. Equipment for decorating a section according to claim 7, wherein said cavity comprises pressurizing means.

13. Equipment for decorating a section according to claim 8, wherein said fusible material is a bath of non-ferrous metal alloys.

14. Equipment for decorating a section according to claim 8, wherein the melting temperature of said fusible material ranges from 220 to 280° C.

15. Equipment for decorating a section according to claim 8, wherein said cavity comprises thermal control means.

16. Equipment for decorating a section according to claim 8, wherein said cavity comprises pressurizing means.
